(19) United States
(12) Patent Application Publication
(10) Pub. No.: US 2026/0185674 A1
(43) Pub. Date: Jul. 2, 2026

(54) ILLUMINATION DEVICE FOR VEHICLES

(71) Applicant: HELLA GMBH & CO. KGAA, Lippstadt (DE)

(72) Inventor: Dieter Nietfeld, Paderborn (DE)

(21) Appl. No.: 18/857,610

(22) PCT Filed: Apr. 6, 2023
(86) PCT No.: PCT/EP2023/059219

§ 371 Date: Oct. 17, 2024

(30) Foreign Application Priority Data
Apr. 29, 2022 (DE) 102022110458.3

(51) Int. Cl. F21S 41/64; B60Q 1/26; B60Q 1/28; F21S 41/20; F21S 41/24; F21S 41/55; F21W 104/00; G02F 1/167; G02F 1/1673; G02F 1/1675; G02F 1/16757; G02F 1/1677; G02F 1/1685

(52) U.S. Cl. CPC F21S 41/645; B60Q 1/2603; B60Q 1/28; F21S 41/24; F21S 41/285; F21S 41/55; G02F 1/167; G02F 1/1673; G02F 1/16757; G02F 1/1677; G02F 1/1685; B60Q 1/2619; F21W 2104/00; G02F 2001/1678

(57) ABSTRACT

The invention relates to an illumination device for vehicles comprising a luminous surface unit securable to a bodywork component and/or a trim component of the vehicle, and comprising a light source for illuminating the luminous surface unit, wherein the luminous surface unit comprises an electrophoretic display having a plurality of color-excitable microcapsules.

### CROSS-REFERENCE TO RELATED APPLICATIONS

This application is the National Stage of International Application No. PCT/EP2023/059219 filed on Apr. 6, 2023, which claims priority to and all advantages of German Patent Application No. 10 2022 110 458.3 filed on Apr. 29, 2022, the disclosures of which are hereby incorporated by reference in their entirety.

### BACKGROUND

The invention relates to an illumination device for vehicles with a luminous surface unit which can be attached to a bodywork component and/or a trim component of the vehicle and with a light source for illuminating the luminous surface unit.

An illumination device for vehicles is known from DE 10 2019 118 527 A1, which is attached to a bodywork part outside the vehicle or to a trim part inside the vehicle for contour lighting. The illumination device consists of an elongated light guide and a light source that couples light into one end of the light guide. The light guide has decoupling means so that the light that is coupled in a linear part of the sheath surface, that simultaneously forms the front side of the illumination device, is decoupled. The light guide thus forms a luminous surface unit of the illumination device. If light of different light colors is to be emitted from the light guide or the luminous surface unit, the light guide must have color changing elements for converting the coupled light if the light source is designed as a laser light source. A disadvantage of the known illumination device is that a specific color tone, for example the vehicle color, can only be set with relatively great effort.

An electrophoretic display is known from WO 2010/003654 A1 and EP 3 234 042 B1, which has a plurality of color-excitable micro capsules. This display is, for example, used as electronic paper for the display of text, for example in the Amazon product Kindle.

In the automotive industry, it is desirable to visually emphasize the contours of the vehicle, for example in the colors of the vehicle manufacturer logo. In addition to design reasons, contour lighting can also help other road users to see the vehicle more easily.

### SUMMARY

The object of the present invention is therefore to further develop an illumination device for vehicles in such a manner that contour lighting with a certain predetermined light color can be provided in a simple manufacturing process.

To achieve this object, the invention in connection with embodiments of the present invention includes a luminous surface unit which comprises an electrophoretic display with a plurality of color-excitable microcapsules.

The particular advantage of the illumination device according to the invention is that the color-excitable microcapsules can be used to easily induce a light color of the luminous surface unit desired by the vehicle manufacturer. When the illumination device is manufactured, the microcapsules are subjected to an electric and/or magnetic field so that the color particles of a specific light color accumulate on a predetermined side of the microcapsules and are fixed there after the field is deactivated. The desired color is thus “burned” into the luminous surface unit during the manufacture of the illumination device. Changing of the light color being emitted is not intended during operation of the vehicle. Advantageously, this allows the luminous surface unit to have a specific light color, for example a light color that matches a component adjacent to the illumination device.

According to a preferred embodiment of the invention, the color particles have at least three or four different color particles or different color particle types, so that, depending on the excitation, these different color particles can be placed on the same side of the microcapsules in a predetermined mixing ratio. If there is a plurality of four different color particles or color particle types, for example with the colors cyan, magenta, yellow and white, more than 4000 different colors can be mixed so that the vehicle manufacturer can be offered a suitable light color for the luminous surface unit.

According to a further development of the invention, several display dots are formed by a plurality of microcapsules, wherein the image dots are dimensioned in the millimeter range and thus only have a low resolution for a human eye. The image dots form the smallest collection of adjacent microcapsules that can still be excited to a predetermined color by the smallest part of the external field. This determines the color resolution of the electrophoretic display. The advantage of this is that a homogeneous color impression of the illumination device can be achieved.

According to a further embodiment of the invention, a light source is switched on or off as a function of an ambient brightness sensor, so that illumination by the luminous surface unit is ensured in darkness or low brightness (twilight).

According to a further embodiment of the invention, a light guide is arranged in front of the electrophoretic display in the main emission direction, into which light can be coupled. This ensures homogeneous lighting over the entire surface of the illumination device.

Further advantages of the invention result from the embodiments discussed herein.

### BRIEF DESCRIPTION OF THE DRAWINGS

Examples embodiments of the invention are explained in more detail below with reference to the drawings.

In the Figures:

FIG. 1 shows a front view of a vehicle with an illumination device according to the invention as contour lighting of the vehicle,

FIG. 2 shows a cross-section of the contour lighting along the intersection line II-II in FIG. 1, and

FIG. 3 shows a cross-section of the contour illumination device along the intersection line II-II in FIG. 1 according to an alternative embodiment.

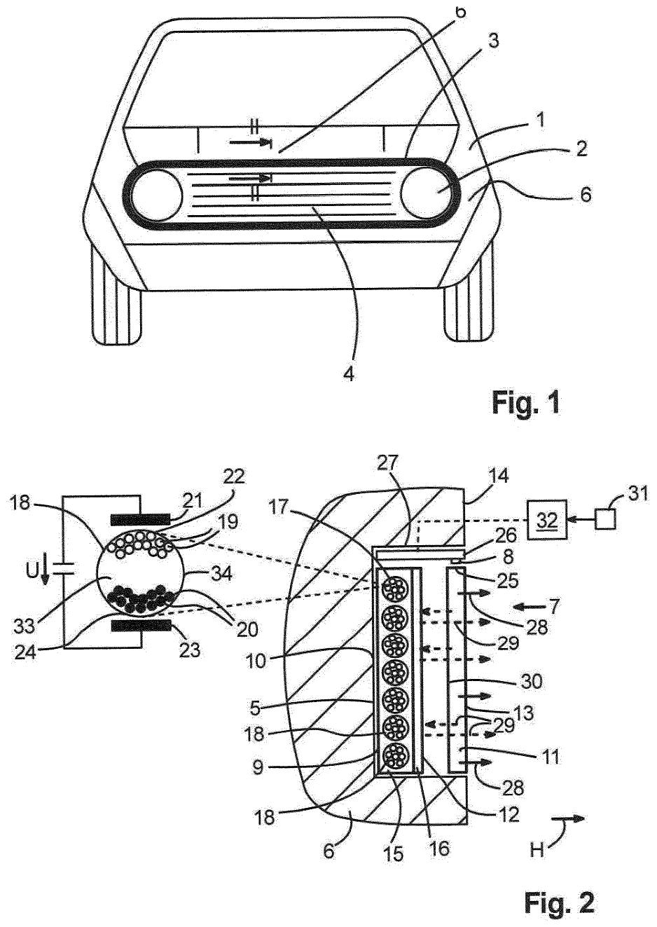

### DETAILED DESCRIPTION

A vehicle 1 has an illumination device 2 in the form of headlights for generating a predetermined light distribution, for example low beam distribution and high beam distribution.

In addition to that, the vehicle 1 has an elongated or linear illumination device 3 for contour lighting. The illumination device 3 comprises a front edge area of the vehicle 1, in which the headlights 2 and a radiator grille 4 are located. In the present example embodiment, the illumination device 3 is closed or oval shaped.

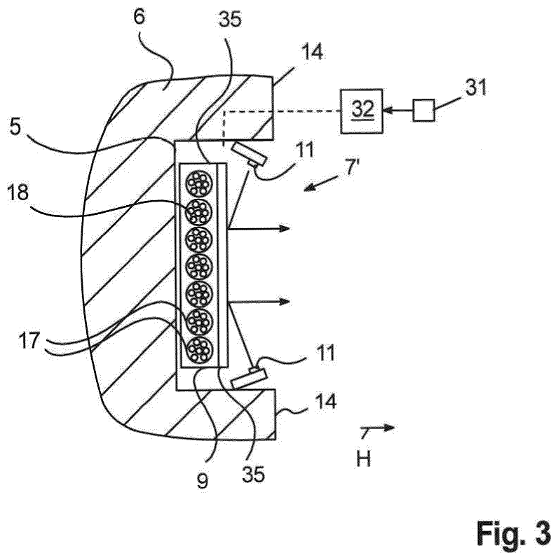

As can be seen from FIGS. 2 and 3, the illumination device 3 extends within a recess 5 of a bodywork component 6 of the vehicle 1. The recess 5 is channel shaped or linear.

The illumination device 3 for contour lighting according to the invention essentially consists of a luminous surface unit 7 and a light source 8. The luminous surface unit 7 emits light from the recess 5 of the bodywork component 6 in the direction of a main emission direction H.

According to a first embodiment of the invention as shown in FIG. 2, the luminous surface unit 7 has, on the one hand, an electrophoretic indicator 9 which rests against a base 10 of the recess 5 and, on the other hand, a light guide 11 which is arranged in front of the indicator 9 in the main emission direction H. In the present example embodiment, the light guide 11 is arranged at a distance from the display 9. According to an alternative embodiment of the invention not shown here, the light guide 11 can also be arranged directly on a front side 12 of the display 9.

The dimensions of the light guide 11 are such that it covers the electrophoretic display 9. A front side 13 of the light guide 11 is preferably flush with a vehicle outer layer 14 formed by the bodywork component 6.

The electrophoretic display 9 consists of a base part 15 and a transparent protective cover 16, which also forms the front side 12 of the display 9. A plurality of image dots 17 or pixels 17 which have dimensions in the millimeter range, is arranged on the base part 15 on a substrate. Each image dot 17 consists of a plurality of microcapsules 18, which have dimensions in the micrometer range, for example in a range between 10 μm and 80 μm. The image dots 17 form the smallest unit of adjacent microcapsules 18 of the same color that can be color-excited by the external field and do not have their own boundary, such as an outer layer.

The microcapsules 18 each have color particles 19, 20 whose position can be changed by means of an externally applied electric or magnetic or electromagnetic field. For example, if the microcapsules 18 have white color particles 19 and black color particles 20 (second color particles of a second color), the application of an electric field, for example an anode 21 on a first side 22 of the microcapsule 18 and a cathode 23 on a second side 24 of the microcapsule 18, can cause the white color particles 19 to accumulate on the first side 22 and the black color particles 20 to accumulate on the opposite second side 24 of the microcapsules 18. If the first sides 22 of the microcapsules 18 are arranged on a side facing the light guide 11 or oriented in the direction of the main radiation direction H, they form the color impression on the front side 12 of the display 9, so that with corresponding equal excitation over the length of the base part 15, the electrophoretic display 9 appears in the light color white. Since the desired white color of the luminous surface unit 7 can be maintained as a visual accentuation of the radiator grille 4 compared to the gray bodywork component 6 even in low light or darkness, the light source 8 is arranged on a narrow side 25 of the light guide 11. The light source 8 is designed as a LED light source, for example, and is arranged on a printed circuit board 26, which is attached to a side wall 27 of the recess 5. The light emitted by the light source 8 is coupled into the light guide 11 at the narrow side 25.

The light guide 11 is designed in such a manner that, on the one hand, a coupled in first light fraction 28 is coupled out at the front side 13 of the light guide 11, see solid line in FIG. 2. On the other hand, the light guide 11 is designed in such a manner that a second light fraction 29 is coupled out at a rear side 30 of the light guide 11 in the direction of the display 9 and reflected to illuminate the display 9, see dashed arrow in FIG. 2. An ambient brightness sensor 31 is provided to detect darkness or twilight in the surroundings of the vehicle 1, which supplies a corresponding signal to the control unit 32 for the light source 8. The control unit 32 for the light source 8 is preferably also used to control the light sources of the headlights 2.

The light guide 11 has a corresponding concentration of decoupling elements within it and/or a number and distribution of decoupling elements on the rear side 30 thereof, so that on the one hand a total reflection of the coupled in light at the flat front side 13 and the flat rear side 30 of the light guide 11, which preferably runs parallel to it, is ensured, the coupled in light being divided into the first light fraction 28 and the second light fraction 29.

Since the first color particles 19 and the second color particles 20 are arranged in a viscous carrier medium 33 of the microcapsules 18, which has a solid or flexible transparent outer layer 34, the color particles 19, 20 remain in the desired position on the opposite sides 22 and 24 of the microcapsules 18 when the electric field is deactivated. The distribution of the color particles 19, 20 is “frozen” and fixed by the electric field after alignment of the color particles 19, 20. This results in a color excitation or color setting by the electric field, which is permanent. The carrier medium 33 is naturally transparent, so that the color effect can be achieved by the color particles 19, 20 dispersed in the carrier medium 33.

According to an alternative embodiment of the invention not shown here, a magnetic or electromagnetic field can also be used for color excitation. This depends on the type of color particles 19, 20 or microcapsules 18.

According to an alternative embodiment not shown here, the microcapsules 18 can also have more than two different types of color particles, for example first color particles of a first color, second color particles of a second color and third color particles of a third color and, if necessary, fourth color particles of a fourth color. By appropriate excitation of these differently electrically or magnetically charged color particles, these color particles can be mixed on the first side 22 of the microcapsules 18 by applying an external field, so that color mixing takes place depending on the size of this external field. The display 9 can thus appear in different colors from three or four different color particles of different colors, for example cyan, magenta, yellow and white or black and white and red or black and white and yellow. For example, the composition of the color particles can be used to make the color impression of the display 9 match that of the neighboring bodywork component 16.

According to a second embodiment of the invention as shown in FIG. 3, a light surface unit 7′ can be formed exclusively by the electrophoretic display 9. A light guide is omitted. The light sources 11 are arranged in the area of opposite narrow sides 35 of the luminous surface unit 7′ or the electrophoretic display 9 to illuminate the electrophoretic display 9 at dusk or in the darkness. In the present example embodiment, the luminous surface unit 7′ is thus recessed relative to the vehicle outer layer 14 of the bodywork component 6. A depth of the luminous surface unit 7′ is smaller than a depth of the recess 5.

According to an alternative embodiment of the invention not shown, the illumination device can also be used for contour illumination in a trim part in an interior of the vehicle 1 instead of in a body component.

If additional anodes and cathodes are arranged in the bodywork component 6 or trim component to generate an electric field, the color impression can also be changed during operation of the illumination device 3 by an appropriate control unit. A certain amount of ambient lighting can thus be generated in the interior of vehicle 1. The color exciting field can be either an electric, magnetic or electromagnetic field. The orientation of the field is preferably perpendicular to the main emission direction H, so that the electrophoretic display 9 is not obscured by the components of the field.

### LIST OF REFERENCE NUMBERS

1 vehicle
2 headlights
3 illumination device
4 radiator grille
5 recess
6 bodywork component
7,7′ luminous surface unit
8 light source
9 electrophoretic display
10 base
11 light guide
12 front side
13 front side
14 vehicle outer layer
15 base part
16 protective cover
17 image dots
18 microcapsules
19 first color particles
20 second color particles
21 anode
22 first side
23 cathode
24 second side
25 narrow side
26 printed circuit board
27 side wall
28 first light fraction
29 second light fraction
30 rear side
31 ambient brightness sensor
32 control unit
33 carrier medium
34 outer layer
35 narrow side
H main emission direction

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An illumination device for a vehicle, the illumination device comprising:
a luminous surface unit which can be fastened to a bodywork component or a trim component of the vehicle, and
a light source for illuminating the luminous surface unit, wherein the luminous surface unit comprises an electrophoretic display with a plurality of color excitable microcapsules.

2. The illumination device according to claim 1, wherein the luminous surface unit comprises a light guide which covers the electrophoretic display on a front side thereof, and wherein the light source is arranged on a narrow side of the light guide, so that light emitted by the light source is coupled into the light guide at the narrow side thereof.

3. The illumination device according to claim 2, wherein:
the light guide has a rear side which is oriented towards the electrophoretic display, on which a part of the coupled in light can be coupled out in the direction of the electrophoretic display, and
the light guide has, on its side oriented away from the electrophoretic display, a front side, on which the other part of the coupled in light in the main emission direction of the illumination device can be coupled out or the part of the coupled in light on the rear side can be coupled out after reflection on the electrophoretic display.

4. The illumination device according to claim 1, wherein the microcapsules each have a plurality of different color particles, so that by exciting the microcapsules with a predetermined electric or magnetic or electromagnetic field, first color particles of a first color or second color particles of a second color can be displaced on a side of the microcapsules oriented towards a front side of the electrophoretic display and can be fixed in this position.

5. The illumination device according to claim 4, wherein the plurality of different color particles are dispersed in a transparent viscous carrier medium, the viscosity of the carrier medium being such that, when the excitation of the microcapsules is deactivated, the plurality of different color particles are retained in the position they are occupying within the microcapsules.

6. The illumination device according to claim 4, wherein the microcapsules have a plurality of first color particles of a first color and of second color particles of a second color and third color particles of a third color and fourth color particles of a fourth color, so that, depending on the excitation of the microcapsules by the predetermined electric or magnetic or electromagnetic field, a positional distribution of the first color particles and of the second color particles and of the third color particles and of the fourth color particles on the first side of the microcapsules can be set to produce a predetermined mixed color on the front side of the electrophoretic display.

7. The illumination device according to claim 4, wherein the microcapsules are arranged on a substrate to form a plurality of image dots, wherein the image dots each have such a number of microcapsules which can be color excited by a smallest part of the predetermined electric or magnetic or electromagnetic field.

8. The illumination device according to claim 1, wherein the luminous surface unit is elongated and extends along an edge of the bodywork component or the trim component of the vehicle.

9. The illumination device according to claim 1, wherein the light source can be switched on and off or dimmed as a function of a signal from an ambient brightness sensor.

10. The illumination device according to claim 1, wherein the microcapsules are excited in such a manner that the luminous surface unit emits light in a color corresponding to the adjacent bodywork component of the vehicle.
